(19) United States
(12) Patent Application Publication
(10) Pub. No.: US 2007/0007396 A1
(43) Pub. Date: Jan. 11, 2007

(54) Fixture for elongate objects

(76) Inventors: Thomas Wien, Schenefeld (DE); Konrad Stocker, Haigerloch (DE)

Correspondence Address: ALIX YALE & RISTAS LLP, 750 MAIN STREET, SUITE 1400, HARTFORD, CT, 06103, US

(21) Appl. No.: 10/555,117

(22) PCT Filed: Apr. 30, 2004
(86) PCT No.: PCT/EP04/04599

§ 371 Date: Nov. 1, 2005

(30) Foreign Application Priority Data
May 2, 2003 (EP) 03010053.1

(51) Int. Cl. F16L 3/22

(52) U.S. Cl. 248/68.1

(57) ABSTRACT

Holder for elongate objects, in particular pairs of pipes (9). A holder part (1) forms two depressions (6), which are arranged symmetrically on both sides of a coupling part (2), for the purpose of accommodating a pair of pipes. The other holder part (11), which can be connected to the first holder part (1) via a second coupling part (12), has two leaves (14), which extend over the depressions (6) in the coupled state and hold the pipes (9) located therein in a fixed position with elastic prestress. The coupling parts comprise a pin (12) having lateral protrusions (18) and an opening (3), accommodating said pin (12), having latching devices (21, 22), which interact with the protrusions when there is a rotation through 90°.

The invention relates to a holder for elongate objects which have a prescribed diameter, for example pipes. These objects should be held in a stable manner which is free from vibrations and in a defined position. It should be possible to mount the holder easily and securely.

In the case of a known holder (GB-B-1 299 529), on which the precharacterizing clause of claim 1 is based, a lower holder part forms a depression for the purpose of accommodating the object. In addition to the depression, it contains a hole, in which a pin is guided, said pin being connected to the second holder part. This holder part has a flat leaf, which lies over the depression in the ready-mounted state and grips, with a tab protrusion, beneath a correspondingly shaped hook of the lower holding part. The tab and the hook form a pair of closure elements which secures the two holder parts in the mounted position. As a result of the fact that the coupling, which connects the two holder parts, is provided on one side of the depression, and the pair of closure elements is provided on the other side, the amount of material and space required for the known apparatus is relatively high. Mounting also requires considerable care to be taken since the relative movement of the two holder parts in relation to one another and the latching process on the closure members need to be matched to one another.

In addition, holders are known, in which the two holder parts are drawn together by special screws (U.S. Pat. No. 5,271,588, EP-A-579 352, EP-A-625 662), which is complex both in production and in use. Finally, a holder is known (U.S. Pat. No. 4,936,530), in which a self-clamping pin is arranged on the upper holder part, said pin being guided freely through an opening in the lower holder part and being anchored in a hole in a bearing structure. The connection of the holder parts is accordingly dependent on the occurrence of an outside operation, namely the anchoring of the pin in the bearing structure. This is disadvantageous. An additional, elastic latching connection between the two holder parts is therefore provided, whose holding performance, however, is not as secure as that of positively latching closure elements.

Starting from the prior art mentioned initially, the invention is therefore based on the object of reducing the production and use complexity. The solution lies in the features of claim 1.

Accordingly, the holder for elongate objects comprises a first holder part, which has at least one accommodating depression for an elongate object and, next to this, a first coupling part, and a second holder part, which has a second coupling part, which fits the first coupling part, and a leaf, which extends over the depression such that it covers it in the holding state. Two depressions and two leaves are preferably in each case provided opposite one another with coupling parts arranged centrally between them, in order that the forces compensate for one another. The dimensions are such that the leaf (leaves) rest(s) elastically, in a prestressed manner, on the object lying in the depression. As a result, the object is held securely and without rattling within a predetermined tolerance range of its diameter. The paired arrangement is therefore advantageous, not only as regards the compensation of forces, but also because there are many applications where pipelines need to be laid in pairs, for example for hydraulic purposes.

The coupling parts are designed such that the desired relative position of the depression and the leaf comes about owing to the engagement. Particularly advantageous is an embodiment in which the coupling parts are in the form of an opening and a pin, which can be rotated one inside the other. In a first position, the holder parts assume a rotation position with respect to one another, in which the leaf lies parallel to the pipe to be held. Owing to a rotation, it reaches the holding position, in which the leaf rests in a prestressed manner on the object. This is possible in accordance with the invention owing to the fact that protrusions and/or recesses are provided which interact with one another in an interlocking manner and allow for the coupling parts to be joined together in the mounting rotation position, while they prevent the holder parts from being removed from one another in the holding rotation position, in which the leaf is located over the depression. If the coupling parts are in the form of an opening and a pin, the opening is expediently provided with at least one, expediently two, opposite edge cut-outs, and the pin has correspondingly one or two protrusions, which can be passed through the edge cutout when the holder parts are joined together in the mounting position and engage behind the opening edge on the other side of the edge cutouts in the holding rotation position. All of the dimensions are in this case selected such that the desired prestress of the leaf on the elongate object having a prescribed diameter comes about precisely when the pin protrusion engages behind the opening edge.

In order that the holder parts cannot be released unintentionally from the holding position, securing devices may be provided, which are expediently in the form of a latching device and counteract the reverse rotation with a force threshold, which cannot be overcome by forces normally occurring during operation. The latching device may be formed, for example, by a ramp, which is provided on the rear opening edge and, during an engaging movement, provides the pin-side protrusion with a gently rising slope, which falls off sharply towards the engaged position. The ramp may be envisaged for the purpose of elastically stressing the device.

In a further feature of the invention, the pin has a hole drilled into it for the purpose of accommodating, for example, a fixing screw.

The holder according to the invention is expediently made from an elastic plastic, for example glass fiber-reinforced polyamide. It may be offered in various sizes so as to fit the different pipe diameters. In order to ensure that mutually fitting holder parts are available in any application case, the two holder parts are produced integrally by an easily breakable material link. Until use, they remain connected to one another and are only then detached from one another.

The invention will be explained in more detail below with reference to the exemplary embodiment illustrated in the drawing, in which:

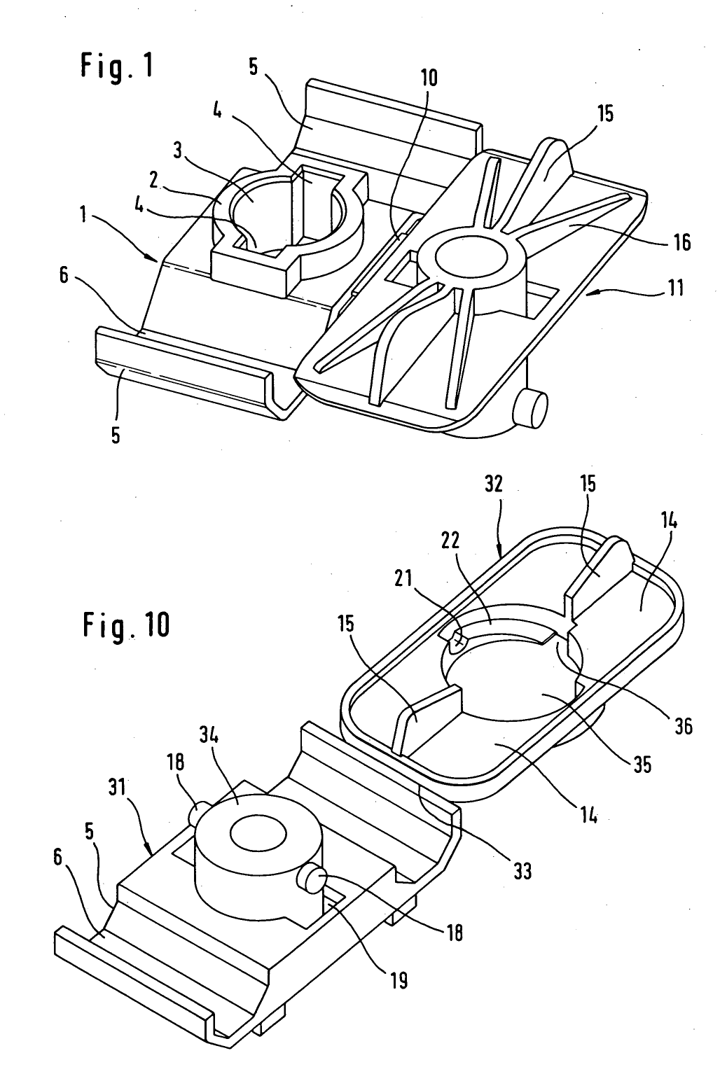

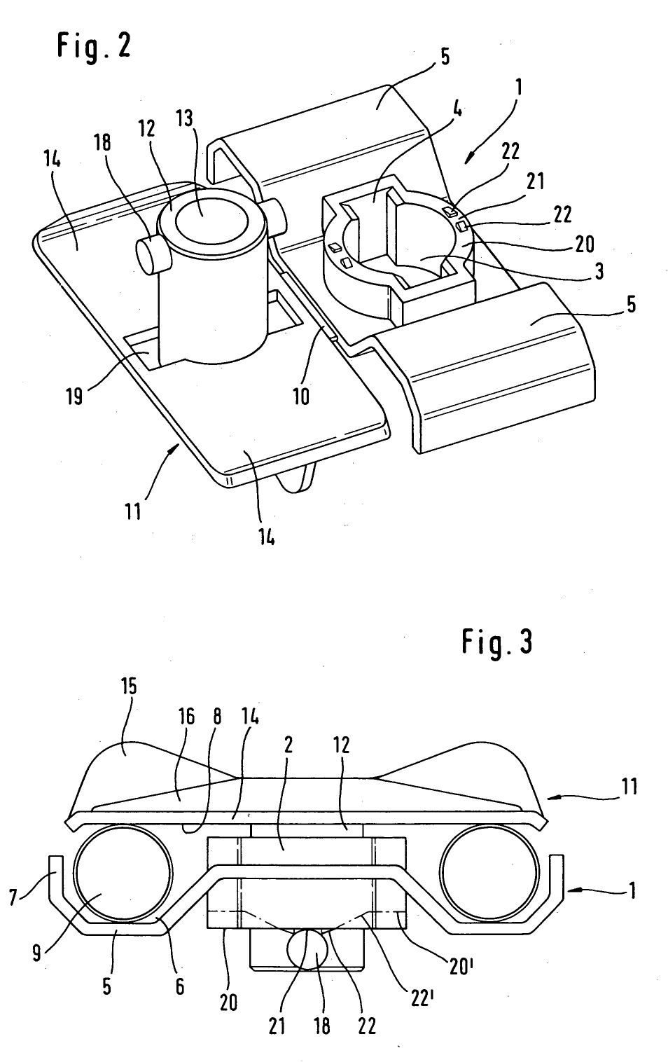

FIGS. 1 and 2 show perspective illustrations, from different sides, of the holder in the production state,

FIG. 3 shows a side view of the holder in the use state,

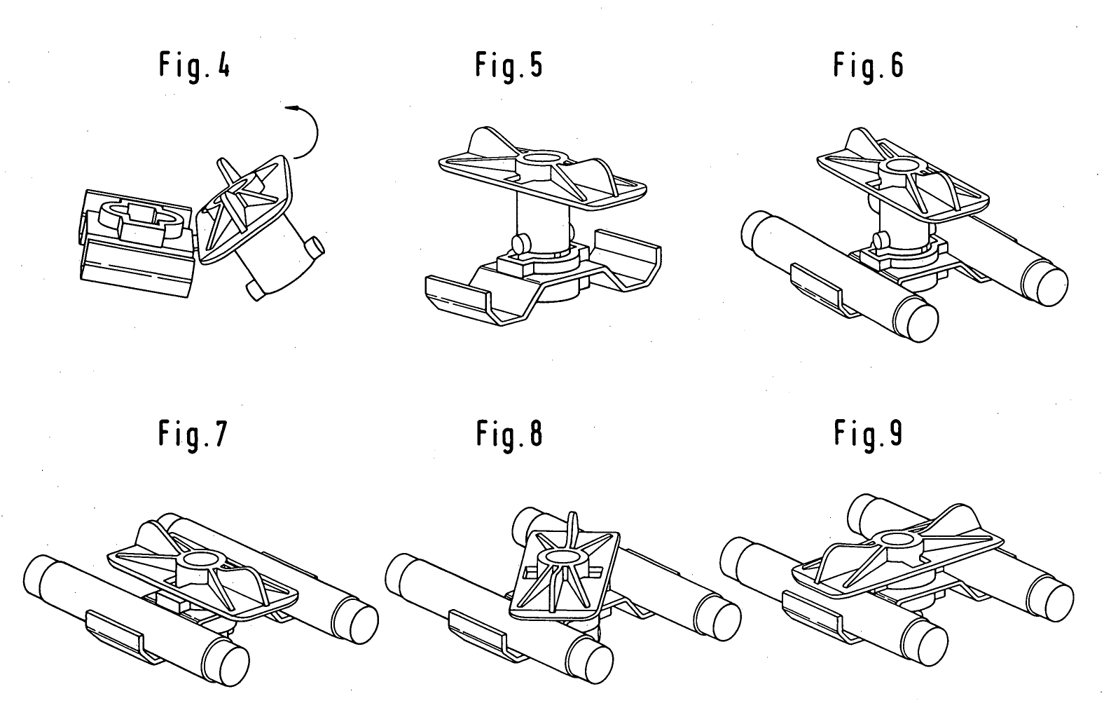

FIGS. 4 to 9 show the holder in the different positions of the application,

FIG. 10 shows an alternative embodiment, and

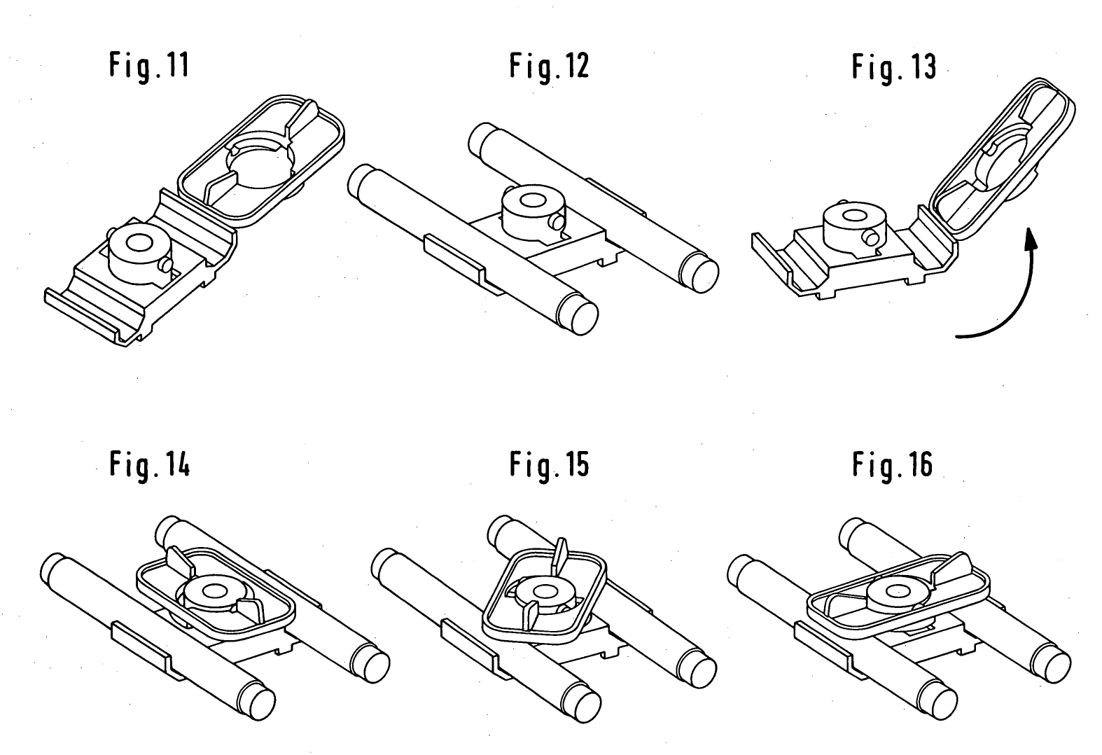

FIGS. 11 to 16 show, in a similar illustration to that in FIGS. 4 to 9, the holder from FIG. 10 in the different positions of the application.

In the embodiment shown in FIGS. 1 to 9, the first holder part 1 has, integrally and in the center, a stable sleeve 2, whose length is not substantially less than its inner diameter. The opening 3 formed therein has grooves 4 on opposite sides.

Located in a symmetrical arrangement to the sides of the central part, containing the sleeve 2, of the first holder part 1 are side parts 5, in which the depressions 6 are formed. The depressions are continuous, parallel indentations, whose outer side walls 7 prevent the pipes held therein from escaping. The side parts 5 are produced from a relatively thin material which is capable of absorbing the required forces but is elastically flexible in order to take account of differences in the diameter of the pipes to be held from the standard diameter.

In the delivered state, the second holder part 11 is connected to the first holder part 1 via a thin, easily destructible material link 10, said holder part 11 having, centrally, a hollow pin 12, whose outer diameter fits with play into the opening 3 in the sleeve 2 of the first holder part 1 and can be rotated therein. The hole 13 within the pin 12 serves the purpose of fixing the arrangement to a holding structure, for example a wall.

On a plane perpendicular to the axis of the pin 12, the second holder part 11 has two symmetrically arranged leaves 14, whose surface is essentially planar on the side on which the pin 12 is also located. On the other side, the leaves 14 are provided with two symmetrically arranged, high ribs 15, which act as a turning handle for the purpose of rotating this holder part. In addition, reinforcing ribs 16 may be provided.

Located symmetrically at the free end of the pin 12 are two lateral protrusions 18, whose size is slightly smaller than the clearance of the grooves 4 such that, when the pin passes through the opening 3, the protrusions 18 can be passed through the grooves 4. The surface of the leaves 4 contains, in the axial projection of the protrusions 18, sections 19, which have no significance for the holding function but merely serve the purpose of allowing the protrusions 18 to have a two-part shape.

The distance between the protrusions 18 and the surface of the leaves 14 and the height of the sleeve 2 in relation to the side parts 5 are dimensioned such that, in the holding position of the holder, which position is illustrated in FIG. 3 and in which position the protrusions 18 grip precisely behind the opening edge 20 of the sleeve 2, a distance is set between the base of the depression 6 and the surface 8 of the leaves 14, which surface faces said depression 6, which is slightly smaller than the diameter of the objects 9 to be held, with the result that said objects are held with a prescribed force with a corresponding elastic deformation of the holder.

FIGS. 4 to 9 illustrate the use step. First (FIG. 4), the holder parts are detached from one another by breaking the link 10. Then (FIGS. 5 and 6), they are joined together with one another and with the objects to be held. The coupling parts are pushed one inside the other (FIG. 7) and rotated (FIG. 8) until they have reached, after a rotation through 90° (FIG. 9), the predetermined holding position in which the protrusions 18 grip behind the opening edge 20 once they have passed the opening 3 and the grooves 4. The opening edge 20 and the protrusions 18 form a pair of closure elements. Any desired recess may also be used instead of the opening edge.

The holding parts are produced from a material, which, on the one hand, allows a slight shaping and, on the other hand, makes it possible to absorb the holding forces elastically and for a long period of time, for example they are produced from glass fiber-reinforced polyamide in an injection molding process.

In order that the pair of closure elements, namely the protrusions 18 and the opening edge 20, cannot be rotated back out of the holding position unintentionally, a latching device is provided. Ramps 22 are provided on the opening edge 20 on both sides of the point 21, at which a protrusion 18 is intended to be located in the holding rotation position, which ramps 22 turn their steep slopes towards the point 21 and are slightly inclined to the other side. When the holder parts are rotated in an engaging manner, the protrusions 18 slide easily over the slightly inclined slopes, whereas, in the opposite direction, they need to overcome the steep slopes, counter to the elastic force, by means of which they are held such that they bear against the opening edge 20. The ramps 22 are so high that it is not necessary during normal use to expect rotation forces to occur, by means of which the coupling could become detached.

In the exemplary embodiment shown by continuous lines in FIG. 3, it is assumed that, when the pin 12 is inserted into the sleeve 2, an axial force is exerted which is so high that the operational deformation of the holder is achieved and the protrusions 18 can engage behind the opening edge 20 during the now following rotation. Simpler mounting can be achieved by the design which is indicated by dash-dotted lines. In this case, the opening edge 20′ is lower in the vicinity of the grooves 4, with the result that it can be reached by the protrusions 18 without any particular force being exerted. Steeply rising ramps 22′ are located between this lower edge 20′ and the latching point 21. In this case, the axial stress of the holder parts is applied by the rotation force used during their rotation.

In the alternative embodiment shown in FIG. 10, the holder part 31 forming the accommodating depressions 6 and the holder part 32 forming the leaves 14 are connected to one another via a destructible, thin material link 33. They can be separated from one another prior to use. However, the following sequences are also possible, inter alia:
prior fitting, screwing-on, separation, closure
screwing-on, fitting, separation, closing.

As a deviation from the first embodiment, the pin 34 is arranged on the holder part 31 forming the depressions, while the opening 35 is provided on the holder part 32 forming the leaves 14. The opening 35 contains edge openings 36 at opposite points, said edge openings 36 corresponding to the grooves 4 of the previously explained exemplary embodiment, in which they form an aperture for the protrusions 18 of the pin 34. Next to the edge openings 36 there is in each case a ramp 22, which leads to an indented point 21. These ramps 22 form, together with the protrusions 18, the pair of closure elements, which secures the two holder parts 31, 32 in the mounted position. In this case, the mounting position is secured by the protrusions 18 being latched elastically into the indented point 21. The elastic force for the latching-in function is brought about by the fact that the holder parts 31, 32 and, in particular, their depressions 5 and leaves 14 are elastic and are dimensioned such that they make a space available for the objects 9 to be accommodated, the width of this space being slightly smaller than their diameter.

Mounting takes place in the same way as described above. The lower holder part 31 is joined together with the objects to be held, and then the holder part 32 is placed on top, to be precise in a direction which extends parallel to the objects. In this case, the pin 34 with the protrusions 18 passes through the openings 35 and 36. If the holder part 32 is now rotated through 900 in the clockwise direction, the protrusions 18 slide along the ramps 22 until they reach the indented latching points 21. The mutual mounting of the holder parts 31, 32 is thus complete. They can now be fixed to a bearing structure in any desired manner. In contrast to the first embodiment, fixing of the objects is possible not only after mounting the objects to be held but also before.

The advantage of the alternative embodiment shown in FIG. 10 consists in the fact that the amount of material required is less and the holder part 32 can have an overall flatter design.

1. A holder for elongate objects having a prescribed diameter, such as pipes, comprising two holder parts, of which the first has at least one accommodating depression for an elongate object and the second has a leaf, which extends over the depression such that it covers it in the connected state of the holder parts, and which two holder parts can be connected by a coupling, whose coupling parts, which are connected integrally with the holder parts, are in the form of an opening and a pin, which can be guided one inside the other in a rotatable manner, a pair of closure elements being provided which is open in a mounting rotation position, in which the at least one leaf is not located over the at least one depression, and is closed in a holding rotation position, in which the leaf is located over the depression, characterized in that the pair of closure elements is arranged at the opening and the pin.

2. The holder as claimed in claim 1, characterized in that the pair of closure elements is formed by at least one edge cutout at the opening and at least one edge protrusion on the pin, which fits through the edge cutout when the holder parts are joined together in the mounting rotation position and engages behind the opening edge on the other side of the edge cutout in the holding rotation position.

3. The holder as claimed in claim 1, characterized in that the pair of closure elements has a latching device for the purpose of securing the holding rotation position.

4. The holder as claimed in claim 1, characterized in that two depressions and two leaves are provided opposite one another on the holder parts with coupling parts arranged centrally between them.

5. The holder as claimed in claim 4 4, characterized in that the at least one leaf is dimensioned so as to rest, with prestress, on the object having a prescribed diameter and lying in the depression, and the holder is elastically flexible.

6. The holder as claimed in claim 1, characterized in that the pin contains a fixing hole.

7. The holder as claimed in claim 1, characterized in that the two holder parts are connected integrally to one another by an easily detachable material link in the production state.

8. The holder as claimed in claim 1, characterized in that the pin is arranged on the holder part having the at least one accommodating depression, and the opening is arranged on the holder part having the at least one leaf.

9. The holder as claimed in claim 8, characterized in that the holder part having the at least one leaf is essentially flat in the form of a plate and has a turning handle.

10. The holder as claimed in claim 2, characterized in that the pair of closure elements has a latching device for the purpose of securing the holding rotation position.
